(19) United States
(12) Patent Application Publication
(10) Pub. No.: US 2015/0027653 A1
(43) Pub. Date: Jan. 29, 2015

(54) SHELL MOULD FOR MANUFACTURING AIRCRAFT TURBOMACHINE BLADED ELEMENTS USING THE LOST-WAX MOULDING TECHNIQUE AND COMPRISING SCREENS THAT FORM HEAT ACCUMULATORS

(71) Applicant: SNECMA, Paris (FR)

(72) Inventors: Didier Guerche, Conflans Ste Honorine (FR); Thibault Dalon, Plaisir (FR)

(73) Assignee: SNECMA, Paris (FR)

(21) Appl. No.: 14/373,681

(22) PCT Filed: Jan. 22, 2013
(86) PCT No.: PCT/FR2013/050134

§ 371 Date: Jul. 22, 2014

(30) Foreign Application Priority Data
Jan. 24, 2012 (FR) 1250677

(51) Int. Cl. B22C 9/04; B22D 25/02; B22C 9/08

(52) U.S. Cl. CPC B22C 9/04; B22C 9/088; B22D 25/02; F05D 2230/211
USPC 164/47; 164/361

(57) ABSTRACT

A shell mold for manufacturing aircraft turbomachine bladed elements using a lost wax molding technique, including: shell mold bladed elements including a blade portion located between a first end part delimiting an impression of a platform and a second end part delimiting an impression of another platform, with the blade portion including a trailing edge zone; a metal feeder having a central axis around which the bladed elements are distributed; and one or a plurality of screens that form heat accumulators arranged in a shell mold interior space, across from inwardly directed trailing edge zones.

### TECHNICAL FIELD

The invention relates to the field of the cluster manufacturing of aircraft turbomachine bladed elements, using the lost-wax moulding technique. Each bladed element can be a sector comprising a plurality of blades, such as a low-pressure feeder sector, or be an individual blade, such as a blade of a turbine or compressor mobile wheel.

The invention relates more particularly to the design of the shell mould in the shape of a cluster, wherein the metal is intended to be cast in order to obtain turbomachine bladed elements.

The invention relates to all types of aircraft turbomachines, in particular turbojets and turboprop engines.

### PRIOR ART

In prior art, it is effectively known to use the lost-wax moulding technique to simultaneously manufacture several aircraft turbomachine bladed elements, such as feeder sectors, or individual blades.

Recall that the lost-wax precision moulding technique consists in creating in wax, via injection into tooling, a model for each of the bladed elements desired. Assembling these models on casting arms also made of wax, which are in turn connected to a metal feeder made of wax, makes it possible to constitute a cluster which is then plunged into various substances in order to form around the latter a ceramic shell mould with a substantially uniform thickness.

The method is continued by melting the wax, which then leaves its exact impression in the ceramic, wherein the molten metal is poured, generally via a casting cup assembled on the metal feeder. After cooling of the metal, the shell mould is destroyed and the metal parts are separated and finished.

This technique offers the advantage of dimensional precision, which makes it possible to reduce and even suppress certain machine tooling. In addition, it offers a very good surface aspect.

More precisely, the shell mould bladed elements are arranged at the periphery of the shell mould, and each has a blade portion of which the trailing edge zone is outwardly-directed from the shell mould. This trailing edge zone is used of course to delimit the impression of the trailing edge of each blade intended to be obtained by the intermediary of the bladed element concerned.

This solution is satisfactory for the obtaining of trailing edges with a standard thickness, for example of a magnitude of 0.7 mm. It is however interesting to reduce the thickness of the trailing edges of the blades in order to improve the performance of aircraft turbomachines. By way of example, increased performance is obtained by providing a thickness of about 0.5 mm on the trailing edges of the feeder sector blades, likewise with a thickness of about 0.45 mm on the trailing edges of individual mobile blades.

However, the current technology can still be perfected in the framework of obtaining such thicknesses, referred to a thin or very thin. Indeed, with such low thicknesses, problems concerning the material not arriving in the impressions defining these trailing edges can arise.

### DISCLOSURE OF THE INVENTION

The invention therefore has for purpose to overcome at least partially the disadvantages mentioned hereinabove, concerning the embodiments of prior art.

To do this, the invention has for object a shell mould for manufacturing a plurality of aircraft turbomachine bladed elements using the lost-wax moulding technique, said shell mould in the shape of a cluster comprising:
a plurality of shell mould bladed elements each intended for the obtaining of one of said turbomachine bladed elements, with each bladed element comprising a blade portion located between a first end part delimiting the impression of a platform as well as a second end part delimiting the impression of another platform, said blade portion comprising a trailing edge zone as well as a leading edge zone that is opposite to it;
a metal feeder having a central axis around which said shell mould bladed elements are distributed; and
a shell mould interior space centred on said central axis, and delimited by said shell mould bladed elements.

According to the invention, said shell mould is provided with one or a plurality of screens that form heat accumulators arranged in the shell mould interior space, across from inwardly-directed trailing edge zones of said shell mould interior space.

The invention is remarkable in that it is entirely suitable for the obtaining of thin or very thin trailing edges, in the terms mentioned hereinabove.

Indeed, during the casting in the shell mould which in general has been preheated, the screen/the screens form a reservoir of heat making it possible to maintain at a high temperature the trailing edge zones located across from them, and of which the position has been voluntarily reversed in relation to prior art so that they are directed inwards of the shell mould. The heat loss is therefore largely reduced, which makes it possible to obtain a better fluidity of the cast metal, and which results in a greater faculty to penetrate into these zones of low thicknesses of the impressions. From this stems an improved moulding precision, and a better metallurgical health of the cast metal, with in particular a decrease in shrinkage.

In addition, by housing therein the screen/the screens, the interior space of the shell mould becomes advantageously functionalised, although it usually remained largely recessed in solutions of prior art. In this regard, it is noted that the presence of the screens does not affect the total encumbrance of the shell mould.

Preferably, each screen extends across from the blade portion, between the first and second end parts delimiting the platform impressions. In other words, it is arranged in such a way that each screen is located only across from the blade portion, i.e. it does not extend sufficiently according to the direction of the central axis of the feeder to be across from the first and second end parts.

Each screen that forms a heat accumulator is preferentially made from a single piece with said shell mould. Each screen is then obtained in a way identical to that of the other members of the shell mould, i.e. using a screen made of wax which is then eliminated or not eliminated, then filled or not filled with metal. Preferably, these screens obtained in a single piece with the shell mould are not filled with metal during the casting.

According to a first possibility, a screen associated with each shell mould bladed element is provided, with each screen being more preferably of a substantially planar form.

According to a possibility, a single screen is provided associated to all said shell mould bladed elements, with said single screen being more preferably of revolutionary shape, centred on said central axis of the metal feeder.

Whether there are one or several screens, their shape can be adapted to be as close as possible to the trailing edge zones of the shell mould bladed elements, in such a way as to procure the greatest effectiveness possible.

In this regard, more preferably, each trailing edge zone is separated from its screen associated with a distance between 1 and 40 mm, with this distance being preferentially substantially constant along each trailing edge of the zone.

Preferably, the shell mould comprises a central support extending from the metal feeder according to the direction of the central axis of the latter, with each screen being arranged around said central support whereon it is added. This central support can also be used in order to porter support reinforcements for the shell mould bladed elements.

Preferably, said shell mould is made of ceramic, in a way known to those skilled in the art.

Preferably, the blade portion of each shell mould bladed element delimits one or several blades. As already mentioned, this can be a bladed element dedicated to obtaining a plurality of blades, such as a low-pressure feeder sector, or a bladed element dedicated to obtaining an individual blade, such as a blade of a turbine or compressor mobile wheel.

The number of these bladed elements distributed circumferentially around the central axis of the feeder can vary, for example from 3 to 10 for sectors each comprising several blades, and for example from 10 to 50 for individual blades.

The invention also has for object a shell mould for manufacturing a plurality of aircraft turbomachine bladed elements using the lost-wax moulding technique, said shell mould in the shape of a cluster comprising:
a plurality of shell mould bladed elements each intended to the obtaining of one of said turbomachine bladed elements;
a metal feeder having a central axis; and
a plurality of metal casting arms distributed around the central axis of the metal feeder, with each of the casting arms having a first end connected to said feeder.

According to the invention, said shell mould is provided with a thermal insulation coating made using a plurality of thermal insulation strips that cover at least a portion of the outside surface of the shell mould.

The invention is remarkable in that it is entirely suitable for obtaining thin or very thin trailing edges, in the sense mentioned hereinabove. Indeed, during and after the casting of the metal in the shell mould, the thermal insulation coating makes it possible to reduce the heat loss and as such maintain the shell mould and the cast metal at a high temperature for an extended period of time. From this stems a better fluidity of the cast metal, which results in a greater faculty to penetrate into the zones of low thicknesses of the impressions, and in particular the trailing edges.

The moulding precision is improved, likewise as the metallurgical health of the cast metal, with in particular a decrease in shrinkage.

In addition, by using a plurality of strips to form the thermal insulation coating, the invention constitutes an advantageous and simple solution making it possible to vary the heat resistance according to the zones of the shell mould, and this in such a way as to obtain a satisfactory filling as well as a good metallurgical health of the cast metal.

Preferably, said coating is carried out using thermal insulation strips each surrounding a shell mould bladed element on at least one radial portion of the latter, and using at least one thermal insulation strip surrounding said shell mould.

Preferably, said coating is carried out in such a way that for each shell mould bladed element, it has a thermal resistance gradient according to the radial direction of said shell mould bladed element. This radial gradient can moreover vary along the contour of the bladed element. In particular, the radial gradient differs between the surface of the outwardly-directed bladed element of the shell mould and its other inwardly-directed surface, across from the central axis of the feeder.

Preferably, said strips are made of rock wool, and for example all have the same thermal resistance. The thicknesses are therefore preferably identical, only the widths can therefore vary. By way of an example for the purposes of information, the thicknesses retained for the various layers can be identical, but with simple or double densities, according to the needs.

Preferably, each shell mould bladed element comprises a blade portion located between a first end part delimiting the impression of a platform as well as a second end part delimiting the impression of another platform, and the second end of each casting arm is connected to said first end part of one of the shell mould bladed elements, of which the second end part is offset from the first end part according to the direction of the central axis of the metal feeder, preferably in the same direction of offsetting as that of the second end of the casting arm in relation to its first end. In addition, each blade portion comprises a trailing edge zone as well as a leading edge zone that is opposite to it.

In the first case where each shell mould bladed element is dedicated to the obtaining of a feeder sector, said thermal insulation coating is particularly effective when it comprises the following thermal insulation strips:
a first strip associated with each shell mould bladed element, with each first strip surrounding its element associated over the entire length of the latter, according to the radial direction of this element;
a second strip associated with each shell mould bladed element, partially recovering the first strip, with each second strip surrounding its element associated over a radial portion of the latter, comprising the first end part and the blade portion, but excluding the second end part;
a third strip surrounding the periphery of the shell mould in such a way as to cover the casting arms, the first end parts of the shell mould bladed elements, as well as an upper radial portion of their blade portions;
a fourth strip partially covering the third strip and surrounding the periphery of the shell mould in such a way as to cover only the casting arms; and
a fifth strip surrounding the periphery of the shell mould in such a way as to cover the shell mould bladed elements, but not the casting arms.

In the second case where each shell mould bladed element is dedicated to obtaining an individual blade, and comprises a reservoir of metal connected to the second end part in such a way as to extend across from and at a distance from the leading edge zone of the bladed element, the thermal insulation coating is particularly effective when it comprises the following thermal insulation strips:
a first strip associated with each shell mould bladed element, each first strip surrounding its element associated on a radial portion of the latter, comprising only a portion of the blade portion (2b) extending from the second end part;
a second strip placed in an annular space centred on the axis of the feeder and defined between the reservoirs and the trailing edge zones, said second strip centred on the central axis of the feeder being arranged in such a way as to cover the first strips and surround exteriorly a radial portion of each bladed element, comprising only a portion of the blade portion extending from the second end part;
a third strip surrounding the periphery of the shell mould in such a way as to cover a radial portion of each shell mould bladed element, comprising the first end part and a portion of the blade portion, but excluding the second end part, with the second and the third strips having ends across from them defining between them an annular window whereon the shell mould is devoid of a strip;
a fourth and a fifth superimposed layers, each surrounding the periphery of the shell mould in such a way as to cover only the casting arms;
a sixth strip surrounding the periphery of the shell mould as well as the third layer in such a way as to cover a radial portion of each shell mould bladed element, comprising the first end part and a portion of the blade portion, but excluding the second end part, with said sixth strip extending to said annular window;
a seventh strip surrounding the periphery of the shell mould in such a way as to cover the surfaces of radially outwardly-directed reservoirs as well as the radial ends of the second end parts;
an eighth strip surrounding the periphery of the shell mould and partially covers said seventh strip in such a way as to cover the surfaces of radially outwardly-directed reservoirs; and
a ninth strip arranged substantially orthogonally to the central axis whereon it is centred, and starting from which it radially extends until it covers the circumferential end of said eighth strip.

Of course, the two aspects of the invention mentioned hereinabove, namely the heat-accumulating screens on the one hand and the thermal insulation coating on the other hand, can be combined.

The invention also has for object a method for manufacturing a plurality of aircraft turbomachine bladed elements using the lost-wax moulding technique, implemented using a shell mould such as described hereinabove.

Preferably, the metal is cast in the shell mould with the central axis of the vertically-directed metal feeder.

When the method is implemented with the screen/the screens made from a single piece with the shell mould, the accumulation of heat is carried out of course at the time where the rest of the shell mould is preheated, before the casting of the metal.

Other advantages and characteristics of the invention shall appear in the detailed and non-restricted description hereinbelow.

### BRIEF DESCRIPTION OF THE DRAWINGS

This description shall be given with regards to the annexed drawings among which;

FIG. 1 shows a perspective view of a turbomachine bladed element intended to be obtained by the implementation of the method according to this invention, with said bladed element having the shape of a low-pressure feeder sector;

FIGS. 2 to 4 show perspective views of a model made of wax used to create a shell mould for the implementation of the method for manufacturing using the lost-wax moulding technique according to the invention, for the purposes of obtaining the element of FIG. 1;

FIG. 4a shows a view that diagrammatically shows the distance of separation between the screens made of wax and the trailing edges of the blades of the replica made of wax;

FIG. 5 shows a perspective view of the shell mould obtained using the model made of wax shown in FIGS. 2 to 4;

FIG. 5a shows a view that diagrammatically shows the distance of separation between the heat-accumulating screens and the trailing edge zones of the shell mould bladed elements;

FIG. 6 shows a view that diagrammatically shows the shell mould provided with a plurality of thermal insulation strips, forming a coating on at least a portion of the outside surface of the shell mould;

FIG. 7 shows a perspective view of another turbomachine bladed element intended to be obtained by the implementation of the method according to this invention, with said bladed element having the shape of an individual mobile blade;

FIGS. 8 and 9 show perspective views of a model made of wax used to create a shell mould for the implementation of the method of manufacturing using the lost-wax moulding technique according to the invention, for the purposes of obtaining the element of FIG. 7;

FIG. 10 shows a view that diagrammatically shows the distance of separation between the screen made of wax and the trailing edges of the blades of the replica made of wax;

FIG. 11 shows a perspective view of the shell mould obtained using the model made of wax shown in FIGS. 8 and 9;

FIG. 11a shows a view that diagrammatically shows the distance of separation between the heat-accumulating screen and the trailing edge zones of the shell mould bladed elements; and

FIG. 12 shows a view that diagrammatically shows the shell mould provided with a plurality of thermal insulation strips, that form a coating on at least a portion of the outside surface of this shell mould.

### DETAILED DESCRIPTION OF PREFERRED EMBODIMENTS

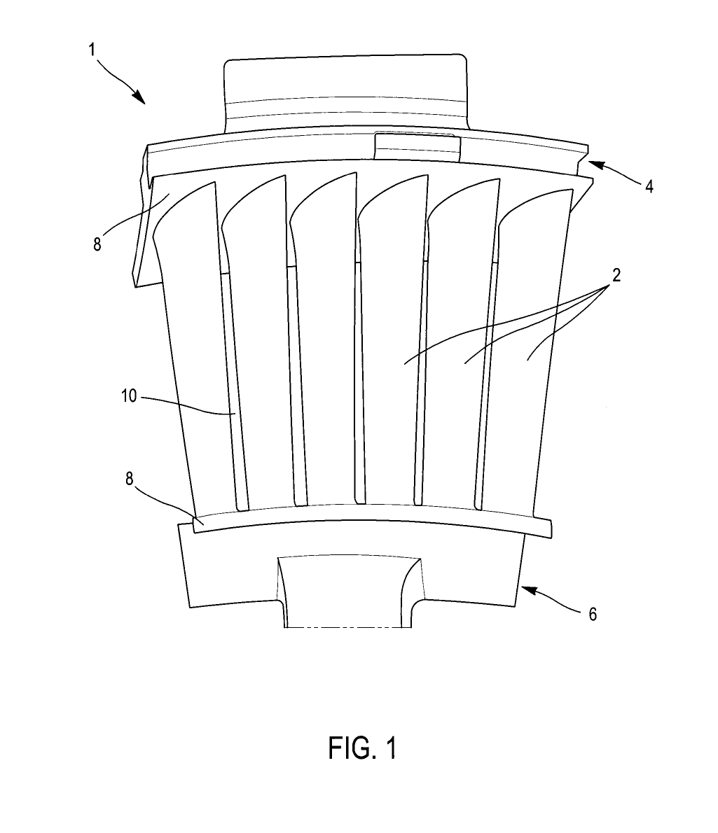

In reference to FIG. 1, a turbine low-pressure feeder sector 1 for an aircraft turbomachine is shown. This sector comprises a plurality of blades 2 arranged between a first end 4 and a second end 6. The two ends 4, 6 respectively form an outside crown angular sector and an inside crown angular sector, and each comprise a platform 8 that delimits a main stream 10 of gas flow. In addition to the platform 8 to which is attached an aerodynamic function, each end further comprises a conventional structure that allows for the mounting of this bladed element on the turbomachine model.

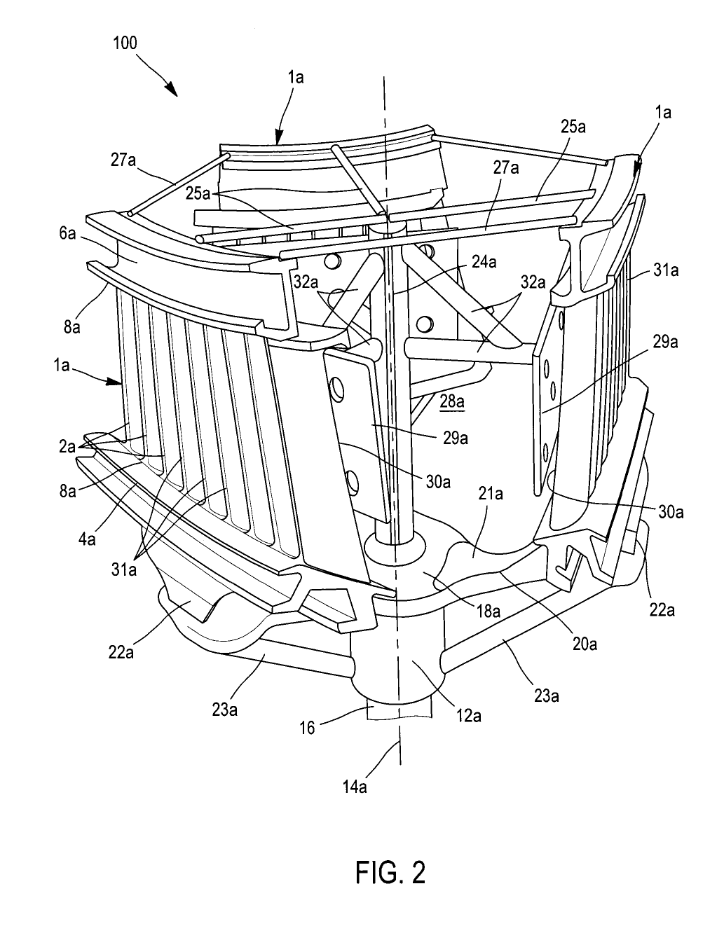

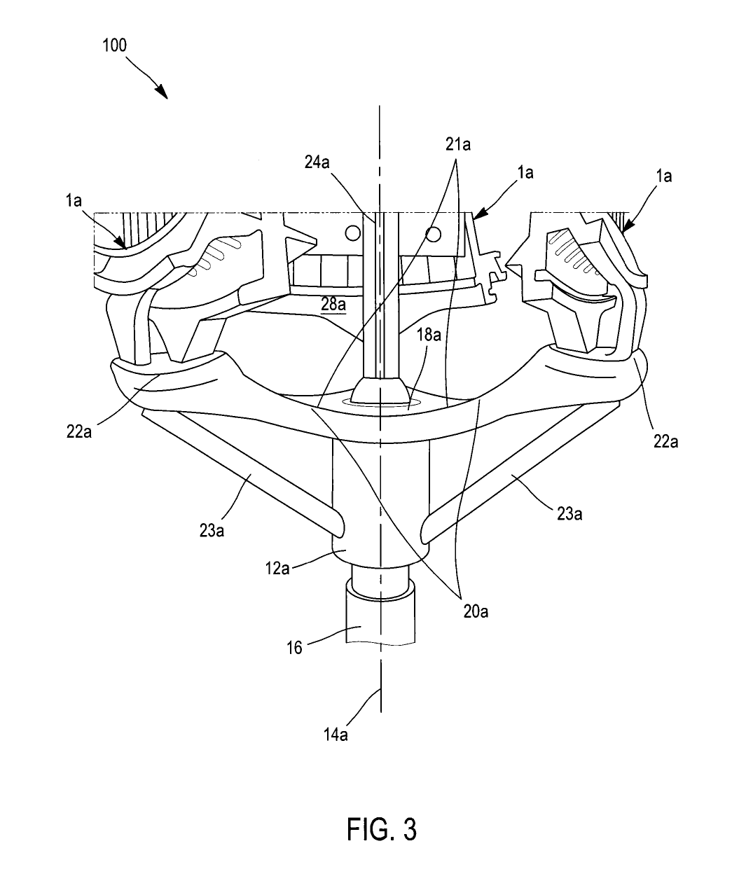

The invention ails to manufacture the feeder sector 1 via a method of lost-wax moulding, of which a preferred embodiment shall now be described in reference to FIGS. 2 to 6.

First of all, a model made of wax is carried out, also called a replica, around which a ceramic shell mould is intended to be formed later.

In FIGS. 2 to 4, the model 100 is shown in a reversed position in relation to the position wherein the shell mould is then filled with metal. This reversed position facilitates the operation of assembling various elements that comprise the model made of wax, which shall now be described.

The model 100 first of all comprises a portion for the distribution of metal, referenced as 12a. It takes a solid revolutionary, cylindrical or tapered shape, with a central axis 14a that coincides with the central axis of the whole of the model made of wax 100. This axis 14a is vertically oriented, and therefore considered as representative of the direction of the height. This portion of distribution 12a is fixed directly to a specific tooling 16, above which it is located.

The portion 12a finishes towards the top by an end 18a of a larger diameter, from which radially extends a plurality of portions 20a for the forming of several casting arms. The portions 20a are here in the number of three, distributed at 120° around the axis 14a. Each portion 20a therefore comprises a first end 21a connected to the widened end 18a of the distribution portion 12a, and extends in a straight or slightly curved manner to a second end 22a. The first and second ends 21a, 22a are offset from each other according to the direction of the axis 14a, with the first being located lower than the second. The average angle of inclination between each portion forming arms 20a and the horizontal is between 5 and 45°.

For each portion forming arms 20a, a reinforcement for maintaining made of wax/ceramic 23a can be provided between the distribution portion 12a and the second end 22a of the portion 20a.

In addition, starting from each second end 22a, a replica is fastened made of wax 1a of the turbomachine feeder sector shown in FIG. 1. This replica 1a therefore comprises a plurality of adjacent blades 2a, arranged between a first end 4a and a second end 6a to which the blades are connected. The two ends 4a, 6a respectively form outside crown angular sector and an inside crown angular sector, and each comprises a platform 8a. In addition to the platform 8a, each end further comprises a conventional structure corresponding to the structure shown in FIG. 1, dedicated to the mounting of the feeder sector 1 on the turbomachine module.

The direction according to which the blades 2a and the ends 4a, 6a succeed corresponds to the radial direction of the bladed sector made of wax 1a, with this radial direction being more preferably substantially parallel to the direction of the axis 14a, i.e. parallel to the direction of the height of the replica 100.

The bladed sectors made of wax 1a extend therefore upwards, by being arranged around the axis 14a, and also around a central support made of wax 24a extending according to this same axis starting from the end 18a of the distribution portion 12a. The support 24a preferentially takes the form of an axis rod 14a, that extends to the vicinity of the ends 6a of the bladed sectors made of wax 1a.

Moreover, as can be seen in FIG. 2, for each bladed sector made of wax 1a, a reinforcement for maintaining made of wax/ceramic 25a can be provided between the top end of the central support rod 24a, and the second end 6a of the sector 1a. In the same way, reinforcements for maintaining made of wax/ceramic 27a connect between them the adjacent ends 6a of the various sectors 1a.

The sectors made of wax 1a form the peripheral wall of the replica made of wax 100. They are spaced circumferentially from one another, and inwardly define an interior space 28a centred on the axis 14a, wherein is therefore located the central support rod 24a.

In this interior space 28a, a plurality of screens made of wax are provided, of which the future shell mould elements intended to be obtained around these screens 29a are provided in order to form heat-accumulating screens.

Each screen 29a is associated with a single bladed sector made of wax 1a, across from which it is located. More precisely, each screen has a substantially planar, square or rectangular shape, of low thickness, for example of a few millimetres only. The screen 29a, substantially parallel to the vertical direction, is located across from trailing edges of the blades made of wax 2a. These trailing edges 30a are therefore inwardly-directed from the shell mould in the direction of the axis 14a, in opposition to the radially outwardly-directed leading edges 31a, in order to constitute the periphery of the replica 100.

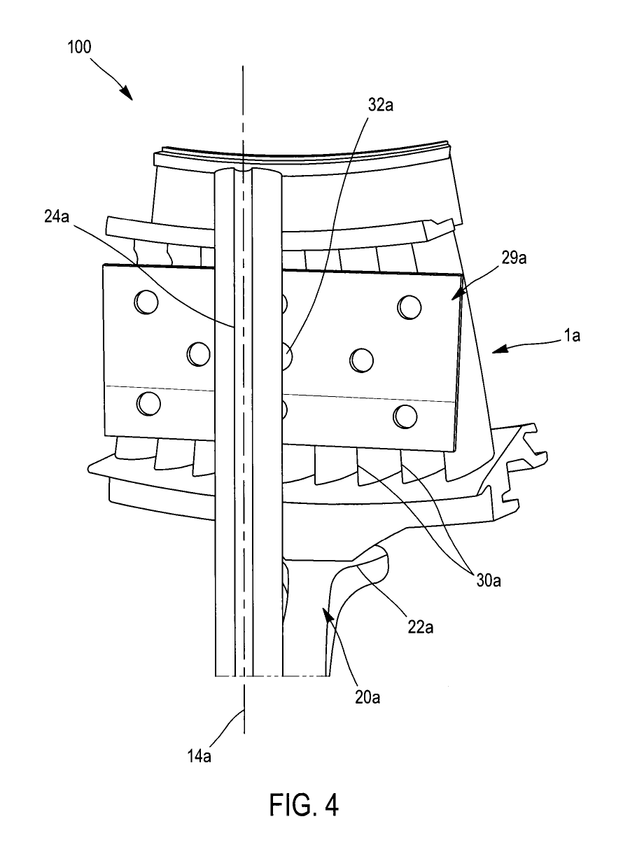

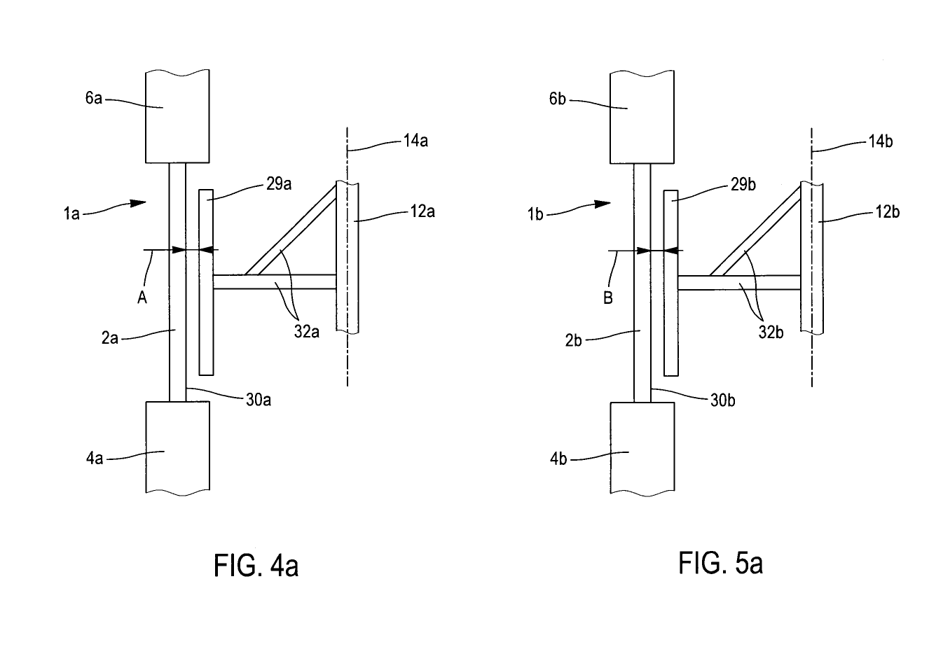

Each screen 29a is added to the central support rod 24a using reinforcements 32a also in the shape of rods of a smaller diameter. As can be seen in FIG. 4, each screen 29a extends across from blades 2a, between the first and second ends 4a, 6a. In other terms, it is arranged in such a way that according to the radial direction of the replica 100, each screen 29a is located only across from blades 2a, i.e. it does not extend sufficiently according to the direction of the central axis 14a in order to be across from first and second ends 4a, 6a.

In FIG. 4a, the fact that each screen 29a is located very close to the trailing edges 30a is diagrammatically shown, since the distance of separation A between the two elements is between 2 and 50 mm, and even more preferentially of a magnitude of to 35 mm, with this distance being substantially constant along the trailing edges 30a.

Once the replica made of wax 100 is created, a shell mould of ceramic 200 is manufactured around the latter in a manner known to those skilled in the art, by soaking in successive substances and baths.

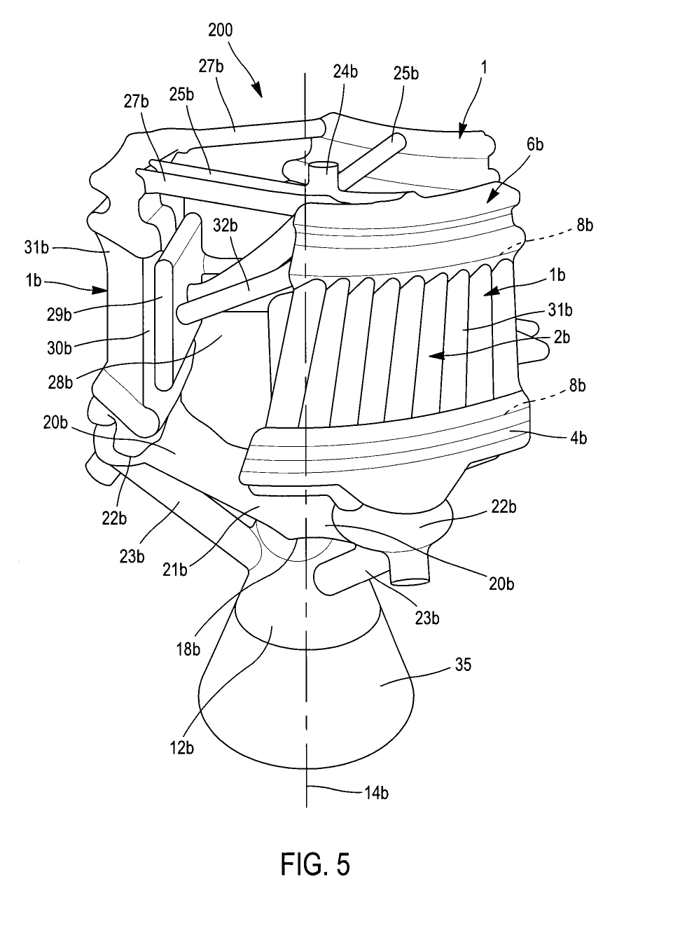

The shell mould 200 that is obtained is shown in FIG. 5. It also has the general shape of a cluster, and of course comprises elements that are similar to those of the replica made of wax 100. These shell mould elements shall now be described, with the shell mould shown in a reversed position in relation to the position wherein it is then filled with metal.

This first entails the metal feeder, referenced as 12b, and therefore having a hollow revolutionary, cylindrical or tapered shape, with a central axis 14a that coincides with the central axis of the shell mould 200. This axis 14b is vertically directed, and therefore is considered as representing the direction of the height. This feeder 12b is fastened directly to a tapered-shape casting cup 35 above which it is located.

The feeder 12b finishes towards the top with a hollow end 18b of a greater diameter, from which radially extend a plurality of metal casting arms 20b. The arms 20b here are of a number of three, distributed at 120° around the axis 14a. Each arm 20b therefore comprises a first end 21b connected to the widened end 28a of the feeder 12b, and extends in a straight or slightly curved manner to a second end 22b. The first and second ends 21b, 22b are offset from one another according to the direction of the axis 14b, with the first being located lower than the second. The average angle of inclination between each arm 20b and the horizontal is between 5 and 45°.

Each arm 20a is therefore provided to be hollow and former a duct for conveying metal after elimination of the wax 20a. Here also, a reinforcement for maintaining 23b can be provided between the distribution portion 12b and the second end 22b of each arm 20b.

Starting with each second end 22b, is a shell mould bladed element 1b. These elements 1b are referred to as bladed because after the elimination of the replica made of wax 1a, they each interiorly form an impression corresponding to one of the feeder sectors 1.

The bladed element 1b, also referred to as shell mould feeder sector, as such comprises a blade portion 2b delimiting the impressions of adjacent blades, with this portion 2b being arranged between a first end part 4b and a second end part 6b. The two end parts 4b, 6b respectively delimit an outside crown angular sector impression and an inside crown angular sector impression, each comprising a platform impression 8b. In addition to the platform 8b, each end part further comprises an impression of conventional structure dedicated to the mounting of the feeder sector 1 on the turbomachine module.

The direction according to which succeed the blade portion 2b and the end parts 4b, 6b corresponds to the radial direction of the shell mould bladed element 1b, with this radial direction being preferably substantially parallel to the direction of the axis 14b, i.e. parallel to the direction of the height of the shell mould 200. In order to be able to benefit later from a high-performance casting via simple gravity, in the direction of the axis 14b, the direction of offsetting of the first end of the arm 21b in relation to the second end of the arm 22b is identical to the direction of offsetting of the first end part 4b in relation to the second end part 6b of the bladed element 1b.

The bladed elements 1b therefore extend upwards, by being arranged around the axis 14b, and also around a central support 24b extending according to this same axis starting from the end 18b of the feeder 12b. The support 24b preferably takes the shape of a hollow cylinder of axis 14b, that extends to the vicinity of the ends 6b of the bladed elements 1b.

In addition, as can be seen in FIG. 5, for each bladed element 1b, a reinforcement for maintaining 25b is provided between the top end of the central support cylinder 24b, and the second end 6b of the element 1b. In the same way, reinforcements for maintaining 27b connecting together the adjacent end parts 6b of the various elements 1b.

The shell mould bladed elements 1b form the peripheral wall of the shell mould 200. They are spaced circumferentially from one another, and define towards the interior an interior space 28b centred on the axis 14b, wherein is therefore located the central support cylinder 24b.

In this interior space 28b, a plurality of screens that form heat accumulators is provided.

Each screen 29b is associated with a single shell mould bladed element 1b, across from which it is located. More precisely, each screen has a substantially hollow and planar, square or rectangular shape, of low thickness, for example of only a few millimetres. The screen 29b, substantially parallel to the vertical direction, is located across from a trailing edge zone of the blade portion 2b. These trailing edge zones 30b are therefore inwardly-directed from the shell mould in the direction of the axis 14b, by opposition to the radially outwardly-directed leading edge zones 31b, in order to constitute the periphery of the shell mould 200.

Each screen 29b is added onto the central support cylinder 24b using reinforcements 32b also in the shape of hollow rods of a smaller diameter. As can be seen in FIG. 5b, each screen 29b extends across from the blade portion 2b, between the first and second end parts 4b, 6b. In other terms, this is done in such a way that according to the radial direction of the shell mould 200, each screen 29b is located only across from the blade portion 2b, i.e. it does not extend sufficiently according to the direction of the central axis 14b to be across from the first and second end parts 4b, 6b.

In FIG. 5a, the fact that each screen 29b is located very close to the trailing edge zones 30b is diagrammatically shown, since the distance of separation B between the two elements is also between 1 and 40 mm, and even more preferentially of a magnitude from 10 to 20 mm, with this distance being substantially identical and constant along each trailing edge of the zone 30b. The number of trailing edges defined by the zone 30b is of course identical to the number of blades that the bladed element 1b defines, for example between 6 and 10.

All of the shell mould elements mentioned hereinabove are made from a single piece of ceramic, during the same step. The thickness of the ceramic shell mould is low, for example of a magnitude of only a few millimetres. It is noted that as for the replica made of wax 100, in the shell mould 200, the numbers of arms 20b, of bladed elements 1b and of screens 29b are identical. However, the same screen may be associated with several shell mould bladed elements, without leaving the scope of the invention.

After the obtaining of the shell mould and the elimination of the replica made of wax 100 enclosed in the latter, the shell mould is preheated to a high temperature in a dedicated oven, for example to 1150° C., in order to favour the fluidity of the metal in the shell mould during the casting. Note that the casting cup 35 is preferentially made integral with the replica made of wax 100 before the forming of the shell mould 200, in such a way that a portion of the latter comes, during its formation, to hug the cup 35.

A step of applying a thermal insulation coating 48, which shall now be described, is more preferably carried out before the preheating.

It consists in coating the outside surface of the shell mould with a plurality of thermal insulation strips, which are here made of rock wool and which can all have the same thickness as well as the same thermal resistance, with then only the arrangement and the width of the strips being specific to each strip. Alternatively, the same thickness can be retained for these strips, with different densities, for example simple or double.

This is first of all a plurality of first strips 50a, each associated with a shell mould bladed element 1b. Each first strip 50a surrounds its associated element 1b over the entire length of the latter, according to the radial direction of this element, i.e. this strip surrounds over 360° the blade portion 2b as well as the two end parts 4b, 6b of the element 1b concerned. The arms 20b are not covered by this first strip, likewise the portion of the end part 6b directed downwards according to the direction of the axis 14b remains uncovered. This portion is however covered by none of the strips that constitute the thermal insulation coating 48. These strips 50a are made of rock wool, more preferably of simple density.

Second strips 50b, also made of rock wool more preferably of simple density, and also each one associated to a shell mould bladed element 1b, partially cover the first strips 50a. Indeed, each second strip 50b surrounds its associated element 1b over a radial portion of the latter, comprising the first end part 4b and the blade portion 2b, but excluding the second end part 6b. This second strip 50b stops as such at the level of the junction between the blade portion 2b and the second end part 6b concerned. Here also, each second strip extends over 360° around the radial direction of the shell mould bladed element 1b, but therefore only over a radial portion of the latter.

A third strip 50c is then provided that surrounds the periphery of the shell mould 200 in such a way as to cover the casting arms 20b, the first end parts 4b of the shell mould bladed elements 1b, as well as an upper radial portion of their blade portions 2b. This here can be a portion extending over substantially half of the total radial length of the blade portion 2b, even over 40 to 50% of this length.

This third strip 50c, preferably of simple density and extending over 360° around the axis 14b, is as such arranged at the periphery of the shell mould 200. Among the elements mentioned hereinabove that it covers, only the portions located radially towards the exterior of this shell mould are directly covered by the third strip 50c, in particular the leading edge zones 31b of the blade portions 2b.

A fourth strip 50d, preferably of double density, partially covers the third strip 50c by surrounding the periphery of the shell mould 200, in such a way as to cover only the casting arms 20b. This fourth strip 50d, which extends over 360° around the axis 14b, therefore does not cover the lower portion of the shell mould. In particular, the elements 1b are not covered by this fourth strip.

A fifth and last strip 50e, preferably of double density, is then applied over 360° around the axis 14b in order to cover a portion of the other strips 50a-50c and surround the periphery of the shell mould 200, in such a way as to cover only the shell mould bladed elements 1b over their entire radial length, but without covering the casting arms 20b.

Note that for the strips 50c, 50d intended to cover the arms 20b, when reinforcements 23b are provided between these arms and the feeder 12b, these same strips are preferably directly pressing all along these arms, having slots that allow for the passage of supper reinforcements 23b.

In the same way, the first and second strips 50a, 50b can be pressing against the surface of the screen 29b located radially towards the inside of the shell mould, and not directly in contact with the trailing edge zones 30b of the bladed elements 1b. This results in a greater facility of setting up these strips.

Note that the fastening of the strips can be carried out in any manner considered as suitable by those skilled in the art, such as using iron wires.

The particular disposition of strips 50a-50e which has just been described makes it possible to obtain a good metallurgical health of the cast metal in the shell mould, in particular thanks to the presence of a thermal resistance gradient of the coating 48 along each bladed element 1b, according to the radial direction of the latter. This gradient extends moreover over the entire shell mould, according to the direction of the axis 14b.

More precisely, the arrangement of these strips allows the metal, after casting in the shell mould, to solidify in the following way. Firstly, the metal solidifies in the first place in the second end part 6b, under the lower end of the strip 50b. The fact that the strips 50b and 50c are offset upwards in relation to the strip 50a then makes it possible for the metal to solidify in the zone of the blade portion 2b located between the lower end of the strip 50c, and the second end part 6b. The arrangement of the strips 50d and 50e finally enable the metal to solidify in the first end part 4b.

The metal of the feeder therefore solidifies progressively from the bottom to the top, by procuring a healthy metallurgical health.

At the exit of the preheating of the shell mould provided with such a coating 48, metal exiting a melting furnace is therefore cast in the impressions via the cup 35 shown in FIG. 5, with the shell mould in reversed position in relation to that shown in this figure, i.e. with the cup 35 open upwards and the axis 14b still vertically directed. In this position, the first end 21b of the arms 20b is then located above the second end 22b.

The molten metal therefore successively follows the cup 35, the feeder 12b, the casting arms 20b, then the shell mould bladed elements 1b, by flowing simply via gravity. Note that prior to the casting, the central support 24b has its end closed off in order to not be filled with metal, and in such a way that the cast metal necessarily passes through the arms 20b before entering into the bladed elements 1b. Because of this, the screens 29b are also devoid of metal, and may or may not retain the wax 29a located interiorly. The reinforcements 23b, the reinforcements 32b and the reinforcements for maintaining 27b are preferentially solid, made of ceramic.

The screens have for role to store heat during the preheating of the shell mould 200, and to restore this heat to the trailing edge zones 30b across from them during the casting, in such a way as to ensure a proper filling thanks to a good fluidity of the metal propitious to the penetration of this metal into the impressions of low thicknesses.

After the cooling of the metal, the shell mould is destroyed, then the feeder sectors 1 are separated from the cluster for possible machining and finishing and control operations.

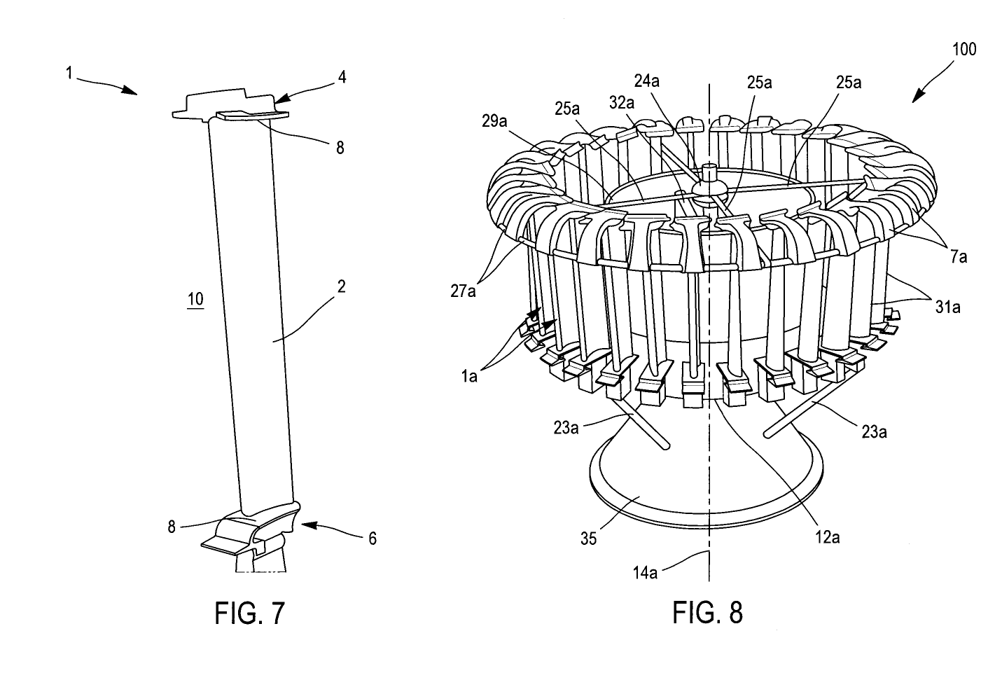

In reference to FIG. 7, a turbine individual mobile blade 1 for an aircraft turbomachine is shown. Unlike the sector 1 shown in FIG. 1, this blade has only a single blade 2, here arranged between a first end 4 and a second end 6.

The invention also aims to manufacture the blade 1 by a method of lost-wax moulding, of which a preferred embodiment is shown in FIGS. 8 to 12.

In these figures, the elements bearing the same numerical references as the elements of FIGS. 1 to 6 correspond to identical or similar elements.

Consequently, a great similarity is observed between the two methods, with only a few minor differences being notable, resulting primarily from the difference in shape between and individual blade and a feeder sector.

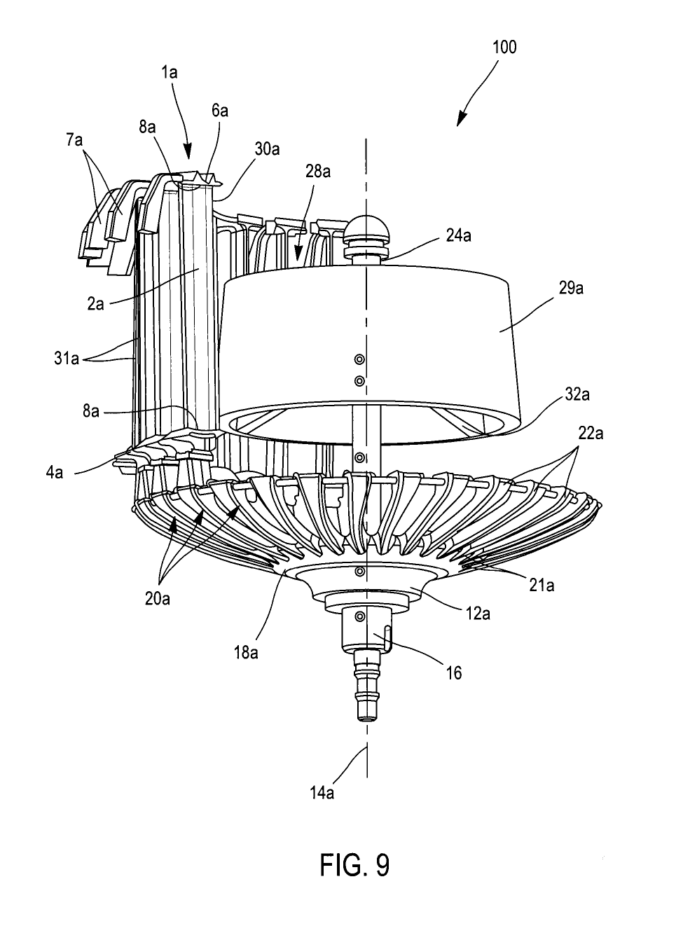

As such, on the replica made of wax 100 shown in FIG. 8 and partially in FIG. 9, it is possible to see that if the number of portions of arms 20a remains identical to the number of individual blades made of wax 1a, the number of reinforcements for maintaining made of wax/ceramic 23a is however lower. For example, only four reinforcements 23a are provided, with these reinforcements able moreover to be directly added on the cup when the latter is already assembled to the replica made of wax 100.

Likewise, the number of reinforcements for maintaining made of wax/ceramic 25a can be reduced, for example to four. These reinforcements 25a are connected on the top end of the central support rod 24a, and on the reinforcements for maintaining made of wax/ceramic 27a connected between them the blades 1a. In this regard, each individual blade made of wax 1a has a flyweights made of wax 7a on its heel, i.e. connected to its end 6a. Each flyweight 7a extends downwards, across from and at a distance from the leading edge 31a of the blade 1a, preferably over a short distance. It is then these flyweights 7a that are connected by the reinforcements for maintaining 27a, at the periphery of the replica made of wax 100.

During the casting, the metal penetrates into the reservoirs 7b of the shell mould formed around these flyweights 7a. These reservoirs make it possible to prevent shrinkage on the heel of the mobile blade. Another function of these reservoirs consists in that during this casting and the cooling, the undesired metallurgical deposits are concentrated in these reservoirs, and therefore do not affect the metallurgical health of the turbomachine blades obtained.

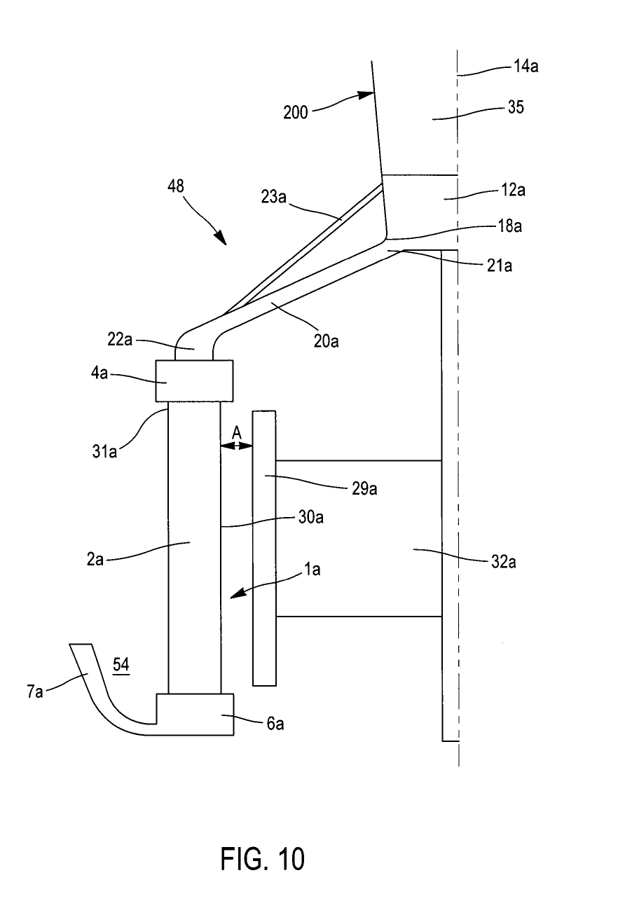

In this configuration, a single screen made of wax 29a is provided associated with all of the blades 1a. This screen 29a is of revolutionary shape centred on the axis 14a, for example cylindrical or tapered, always with the same characteristics of spacing with regards to the blades, as has been diagrammed in FIG. 10.

The screen 29a also has an arrangement and dimensions according to the direction of the axis 14b that are identical or similar to those of the screens 29a of the preceding embodiment. It is added on the central support rod 24a using reinforcements 32a in the form of ribs of low thickness.

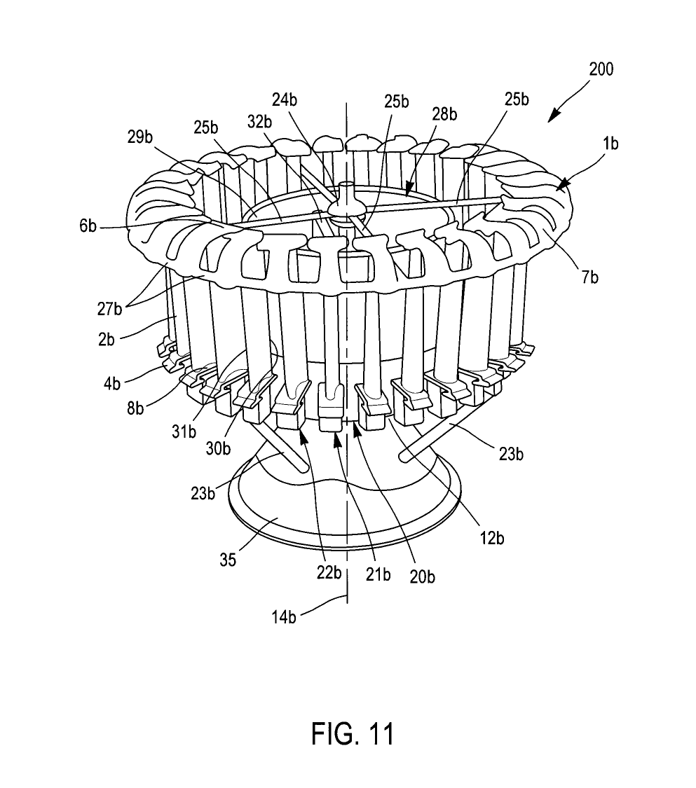

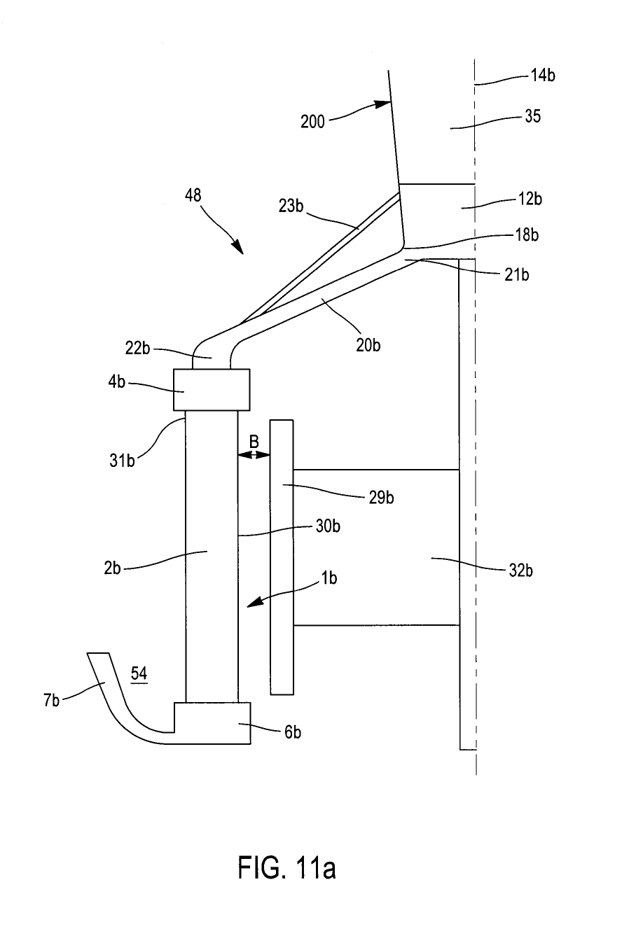

Furthermore, these slight structural modifications necessarily have an impact on the constitution of the shell mould 200 shown in FIG. 11. As such, all of the elements of the replica 100 mentioned hereinabove give rise to shell mould elements identified with the same numerical radical, followed by the letter “b”. In this respect, note that the single heat-accumulating screen 29b has the same characteristics of spacing with regards to the trailing edge zones 30b, as has been diagrammed in FIG. 11a.

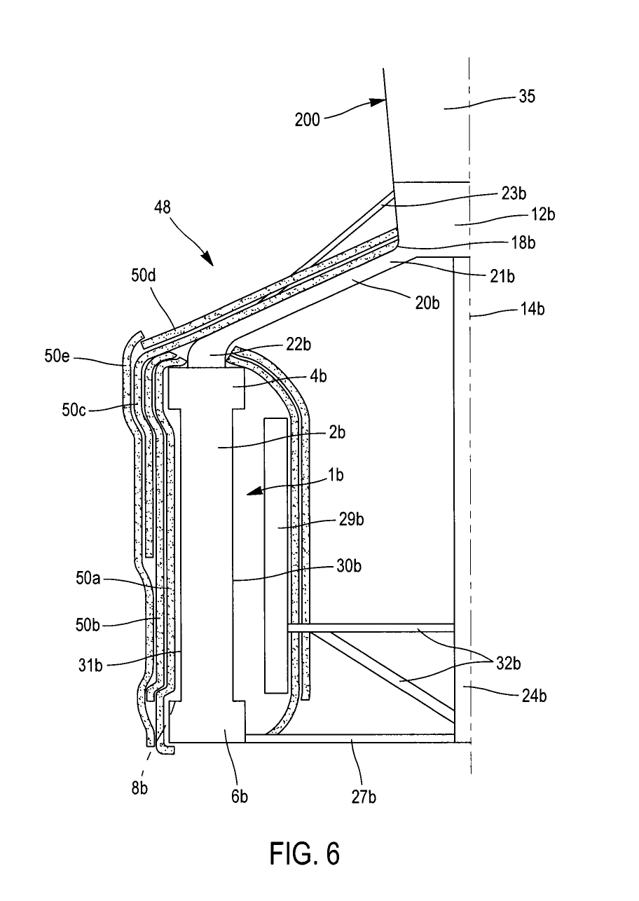

The later operations of preheating, casting and cooling of the metal are carried out in a manner that is identical or similar to that described for the preceding embodiment, with only the application of the thermal insulation coating 48 being distinct from that described in reference to FIG. 6.

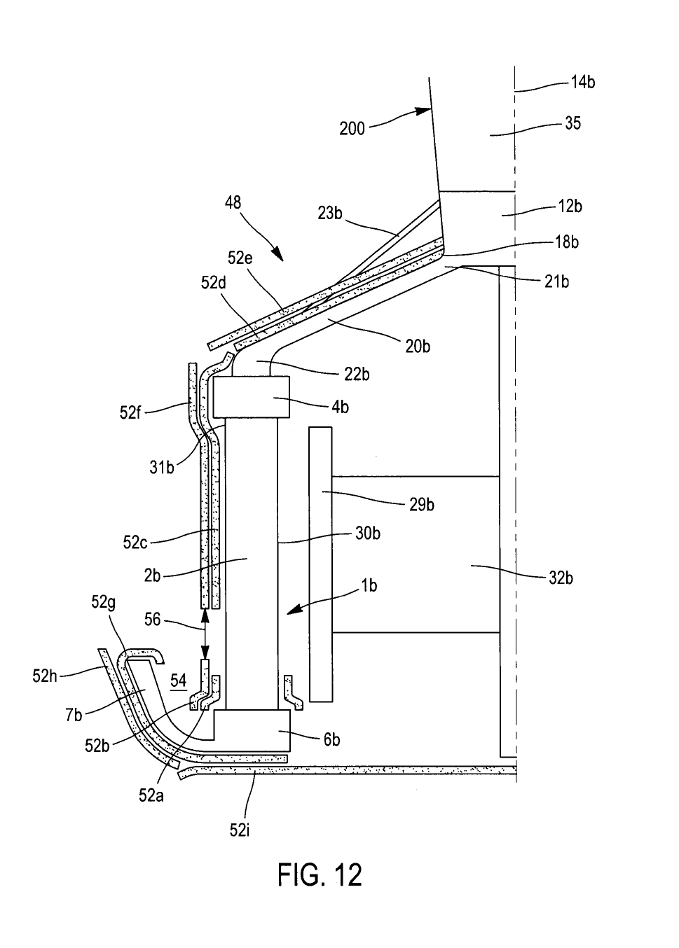

Indeed, in reference to FIG. 12, the thermal insulation coating 48 first of all comprises first strips 52a each associated to a shell mould bladed element 1b, with each first strip surrounding its associated element 1b over a radial portion of the latter, comprising only a lower portion of the blade portion 2b that extends starting from the second end part 6b. This here can be a portion extending over 10 to 30% of the total radial length of the blade portion 2b.

A second strip 52b is then provided placed in an annular space 54 centred on the axis 14b, and defined between the reservoirs 7b and the leading edge zones 31b. The second strip 52b is centred on the axis 14b and arranged in such a way as to cover the first strips 52a and exteriorly surround a radial portion of each bladed element 1b, comprising a lower portion of the blade portion 2b extending from the second end part 6b. This is more preferably a portion of identical or similar length to that covered by the first strips 52a, and even extending slightly beyond the strips 52a, upwards. The strips 52a and 52b are more preferably of simple density.

A third strip 52c, preferably of simple density, surrounds the periphery of the shell mould 200, in such a way as to cover a radial portion of each shell mould bladed element 1b, comprising the first end part 4b and a portion of the blade portion 2b, but excluding the second end part 6b. In this regard, note that the second and the third strips 52b, 52c having ends across from them defining between them an annular window 56 centred on the axis 14b, on which the shell mould 200 is devoid of a strip. This window 56, which subsists once all of the strips have been installed, can have a height of a magnitude of 20 to 60 mm.

Then, a fourth and a fifth strips 52d, 52e, each of double density, are superimposed in order to each surround the periphery of the shell mould 200, in such a way as to cover only the casting arms 20b. These two strips also extend over 360° around the axis 14b.

On the other hand, a sixth strip 52f of double density is provided surrounding the periphery of the shell mould 200 as well as the third strip 52c, in such a way as to cover a radial portion of each shell mould bladed element 1b, comprising the first end part 4b and a portion of the blade portion 2b, but excluding the second end part 6b. This sixth strip 52f extends to the annular window 56, without obstructing it.

A seventh strip 52g of simple density extending over 360° around the axis 14b surrounds the periphery of the shell mould 200 in such a way as to cover the surfaces of the radially outwardly-directed reservoirs 7b, as well as the radial ends of the second end parts 6b.

In a similar manner, an eighth strip 52h of double density surrounds over 360° the periphery of the shell mould 200 and partially covers this seventh strip 52g, in such a way as to cover the surfaces of the radially outwardly-directed reservoirs 7b, but without covering the radial ends of the second end parts 6b.

Finally, a ninth strip 52i is arranged substantially orthogonally to the central axis 14b whereon it is centred, and starting from which it extends radially until it covers the circumferential end of said eighth strip 52h. This last strip 52i therefore allows the coating 48 to close the lower end of the shell mould 200.

Note that for the strips 52d and 52e intended to cover the arms 20b, when reinforcements 23b are provided between these arms and the feeder 12b, these same strips are preferably directly pressing all along these arms, having slots allowing for the passage of upper reinforcements 23b.

Here also, the fastening of the strips can be carried out in any manner considered as suitable by those skilled in the art, such as using iron wires.

The particular arrangement of the strips 52a-52i that has just been described makes it possible to obtain good metallurgical health of the metal cast in the shell mould, in particular thanks to the presence of a thermal resistance gradient of the coating 48 along each bladed element 1b, according to the radial direction of the latter. This gradient extends moreover over the entire shell mould, according to the direction of the axis 14b.

More precisely, the arrangement of these strips allows the metal, after casting in the shell mould, to solidify in the following way. Firstly, the metal begins to solidify in the zone located on the window 56, devoid of rock wool. The arrangement of the layers 52a, 52b and 52c, 52f allows the metal to solidify symmetrically in the blade portion 2b on either side of the window, then still symmetrically, in the second end part 6b and the upper portion of the blade portion 2b. Finally, the solidification of the metal is completed in the first end part 4b.

Of course, various modifications can be made by those skilled in the art to the invention that has just been described, only in terms of non-restricted examples.

1-12. (canceled)

13. A shell mold for manufacturing a plurality aircraft turbomachine bladed elements using a lost wax molding technique, the shell mold being in a shape of a cluster and comprising:
a plurality of shell mold bladed elements each configured to obtain one of the turbomachine bladed elements, each shell mold bladed element comprising a blade portion located between a first end part delimiting an impression of a platform and a second end part delimiting an impression of another platform, the blade portion comprising a trailing edge zone and an opposite leading edge zone;
a metal feeder having a central axis around which the shell mold bladed elements are distributed;
a shell mold interior space centered on the central axis, and delimited by the shell mold bladed elements; and
a plurality of screens that form heat accumulators arranged in the shell mold interior space, across from inwardly-directed trailing edge zones of the shell mold interior space.

14. A shell mold according to claim 13, wherein each screen that forms a heat accumulator is made from a single piece with the shell mold.

15. A shell mold according to claim 16, wherein one of the screens, or a screen of substantially planar shape, is provided associated to each shell mold bladed element.

16. A shell mold according to claim 13, further comprising a single screen, or a single screen of revolutionary shape, provided associated to all the shell mold bladed elements, centered on the central axis of the metal feeder.

17. A shell mold as claimed in claim 13, wherein each trailing edge zone is separated from its associated screen by a distance between 1 and 40 mm.

18. A shell mold as claimed in claim 13, further comprising a central support extending from the metal feeder according to a direction of the central axis of the metal feeder, with each screen being arranged around the central support whereon the respective screen is added.

19. A shell mold as claimed in claim 13, made of ceramic.

20. A shell mold as claimed in claim 13, wherein the blade portion of each shell mold bladed element delimits one or plural blades.

21. A shell mold for manufacturing a plurality of aircraft turbomachine bladed elements using a lost wax molding technique, the shell mold being in a shape of a cluster and comprising:
a plurality of shell mold bladed elements each configured to obtain one of the turbomachine bladed elements;
a metal feeder having a central axis;
a plurality of metal casting arms distributed around the central axis of the metal feeder, with each of the casting arms including a first end connected to the feeder; and
a thermal insulation coating carried out using a plurality of thermal insulation strips covering at least a portion of an outside surface of the shell mold.

22. A shell mold according to claim 21, wherein the coating is carried out using thermal insulation strips each surrounding a shell mold bladed element over at least one radial portion of the shell mold bladed element, and using at least one thermal insulation strip surrounding the shell mold.

23. A method for manufacturing a plurality of aircraft turbomachine bladed elements using the lost wax molding technique, implemented using a shell mold as claimed in claim 13.

24. A method according to claim 23, wherein the metal is cast in the shell mold with the central axis of the vertically-directed metal feeder.
